(19) United States
(12) Patent Application Publication
(10) Pub. No.: US 2026/0302866 A1
(43) Pub. Date: Oct. 1, 2026

(54) STATOR OF AN ELECTRIC MACHINE

(71) Applicant: Robert Bosch GmbH, Stuttgart (DE)

(72) Inventors: Daniel Kuehbacher, Stuttgart (DE); Felix Bensing, Stuttgart (DE); Jannik Stammler, Stuttgart (DE); Ngoc Duc Nguyen, Hannover (DE); Sven Herrmann, Sibbesse (DE)

(21) Appl. No.: 19/478,429

(22) PCT Filed: Mar. 20, 2024
(86) PCT No.: PCT/EP2024/057412

§ 371 Date: Oct. 24, 2025

(30) Foreign Application Priority Data
Apr. 26, 2023 (DE) 10 2023 203 852.8

(51) Int. Cl. H02K 3/34

(52) U.S. Cl. CPC H02K 3/345

(57) ABSTRACT

Stator of an electric machine (2), comprising a laminated core (3) which comprises core laminations (8), and on which stator teeth (4) and stator grooves (5) located between the stator teeth (4) are formed, said laminated core extending about a stator axis (7), and comprising a stator winding (6) which runs in the stator grooves (5), wherein, in the laminated core, at least one set (13) of three first stator partial cores (3.1) which are turned in opposite direction are provided in the laminated core (3) for clamping the stator winding (6) at clamping points (10) of the stator grooves (5), wherein two of the first stator partial cores (3.1) of each set (13) are turned in one circumferential direction, and the remaining first stator partial cores (3.1) of the set (13) are turned in the opposite direction about the stator axis (7), wherein protective sleeves (11) are provided in the stator grooves (5) of the laminated core (3) in the region of the turned first stator partial cores (3.1), said protective sleeves protecting the stator winding (6) from being damaged by the turned first stator partial cores (3.1) and, in particular, being electrically insulated, characterized in that at least one of the protective sleeves (11) has at least one collar (12) which is angled relative to a groove section (11.1) of the protective sleeve (11) and which is provided for axially supporting against one of the stator teeth (4) of one of the first stator partial cores (3.1).

### BACKGROUND

The invention relates to a stator of an electric machine.

A stator of an electric machine is already known from DE102021204202 A1, having a laminated core comprising sheet metal laminations, on which stator teeth and stator grooves located between the stator teeth are formed, and which extends about a stator axis, and having a stator winding running in the stator grooves, wherein at least one set of three oppositely turned first stator partial cores is provided in the laminated core for clamping the stator winding at clamping points of the stator grooves, wherein two of the first stator partial cores of the respective set are turned in one circumferential direction, and the remaining first stator partial core of the set is turned in the opposite direction about the stator axis, wherein protective sleeves are provided in the stator grooves of the laminated core in the region of the turned first stator partial cores, which protective sleeves protect the stator winding from damage by the turned first stator partial cores.

### SUMMARY

In contrast, the stator of the electric machine according to the invention has the advantage that the assembly of the protective sleeves is simplified in that the protective sleeves are insertable into the stator grooves of a stator partial core or a set of stator partial cores, and are brought into a defined axial position and held there when inserted. According to the invention, this is achieved by at least one of the protective sleeves having at least one collar, which is provided for axial support, on one of the stator teeth of one of the first stator partial cores, and is angled relative to a groove section of the protective sleeve.

As the protective sleeves are securely fixed in the laminated core in the axial direction, the conductors or conductor bundles of the stator winding may be inserted into the protective sleeves with a low clearance fit or with a press fit, and pushed through, such that a high groove fill factor is achievable in the stator grooves.

According to an advantageous design, the collar of the respective protective sleeve is formed on at least one flank side, which faces a tooth flank of the respective stator groove, and/or on a narrow side connecting the flank sides. The collar of the respective protective sleeve may also be an annular collar.

It is particularly advantageous if the respective first stator partial core comprises at least one end lamination on at least one of the two end laminations, the groove contours of which are set back relative to the other plates to form an installation space for accommodating the collar of the respective protective sleeve. Alternatively or additionally, the collar of the respective protective sleeve may be clamped between laminations of the laminated core. In this way, the protective sleeve is reliably fixed to the laminated core via the collar.

It is also advantageous if the collars of a plurality, in particular, all, protective sleeves of one of the first stator partial cores or of a set of first stator partial cores are integrally joined to form a protective sleeve unit, wherein the protective sleeve unit has a lamination section for connecting the protective sleeves, wherein the lamination section of the protective sleeve unit is formed in a plane between two laminations of the laminated core. This simplifies the installation of the protective sleeves, as fewer parts need to be fitted to the laminated core.

It is particularly advantageous if the respective protective sleeve extends in the axial direction, according to a first variant, in only one of the first stator partial cores of the respective set, or, according to a second variant, in all first stator partial cores of the set. The protective sleeves according to the first variant do not have to be deformed when the first stator partial cores are turned. The protective sleeves according to the second variant must be able to accommodate deformation when the first stator partial cores are turned, but have the advantage that fewer parts need to be mounted on the laminated core. In addition, in the variant with recessed groove contours in the end laminations, less iron has to be omitted from the end laminations of the first stator stacks.

It is furthermore advantageous if the protective sleeves are formed closed in the circumferential direction or interrupted by a slot, wherein the slot is provided, in particular, at edges of the protective sleeves running in the axial direction. The closed protective sleeves have the advantage that they are very dimensionally stable and easy to fit. The advantage of the slotted protective sleeves is that the conductor bundles of the stator winding may be inserted or pushed through the protective sleeves more easily, especially if the protective sleeves are manufactured with demolding chamfers.

According to an advantageous design, the groove section of the protective sleeves may be configured to match the shape of the stator grooves, in particular, trapezoidal, rectangular, sleeve-shaped, partially trapezoidal, partially rectangular or U-shaped in cross-section.

It is also advantageous if the material of the respective protective sleeve is a plastic, in particular, an elastomer or thermoplastic elastomer, or a ceramic. In this way, the tooth flanks of the turned first stator partial core are covered with an electrically insulating material. The clamping forces are exerted on the stator winding via the protective sleeves. An elastic plastic for the protective sleeves prevents the conductors of the stator winding from being damaged at the clamping points by the clamping forces due to the turning of the first stator partial cores.

Moreover, it is also advantageous if each of the stator grooves may be flowed through by a cooling medium, in particular, oil, along a cooling path, wherein bypasses are provided on the protective sleeves to bypass the clamping points, in particular, on one of the inner narrow sides of the protective sleeves, in particular, on an inner narrow side facing or facing away from the stator yoke. In this way, the cooling medium may be routed past the clamping points with minimal pressure loss.

It is advantageous if the stator teeth are joined to one another via an annular stator yoke and each have a tooth end facing away from the stator yoke, which is designed, in particular, as a tooth head, wherein the stator grooves have groove slots formed between the respective tooth ends, wherein a radially projecting web cut is formed on a narrow side of the respective protective sleeve facing away from the stator yoke, which extends into the respective useable slot and extends in the axial direction. In this way, meandering flow guidance may be achieved in the groove gap channels of the stator grooves. By means of the web section, the groove slot is locally closed in the region of a clamping point, such that the flow must pass via a bypass in the groove base past the respective clamping point. This achieves better and/or more even cooling of the stator winding conductors.

It is further advantageous if at least a second stator partial core is provided in the laminated core, which is arranged between a first stator partial core of a set of first stator partial cores, and/or between two sets of a first stator partial core, and is oriented in the circumferential direction in such a way that the conductors of the stator winding in each stator groove of the second stator partial core run along the stator groove at a distance from the two tooth flanks of the stator groove, wherein groove gap channels are formed in the stator grooves. In this way, the cooling medium may be guided through the stator grooves with low pressure loss.

A stator sleeve may be provided on the inside diameter of the laminated core to seal the groove slots.

The invention also relates to an electric machine with a stator according to the invention.

### BRIEF DESCRIPTION OF THE DRAWINGS

Exemplary embodiments of the invention are shown in simplified form in the drawing and explained in more detail in the following description.

It shows:

FIG. 1 a sectional view of an electric machine with a stator and a rotor,

FIG. 2 a partial view of a stator according to FIG. 1 with a plurality of turned first stator partial cores, in the stator grooves of which protective sleeves according to the invention are provided according to a first exemplary embodiment;

FIG. 3 a single first stator partial core according to FIG. 2 with protective sleeves according to the invention, according to a first exemplary embodiment,

FIG. 4 a partial view of a stator according to FIG. 1 with a plurality of as yet unturned first stator partial cores, in the stator grooves of which protective sleeves according to the invention are provided, according to a second exemplary embodiment,

FIG. 5 a first variant of a protective sleeve according to the invention as shown in FIG. 2 to FIG. 4,

FIG. 6 a second variant of a protective sleeve according to the invention according to FIG. 2 to FIG. 4 and

FIG. 7 a further view of the protective sleeve according to FIG. 5.

### DETAILED DESCRIPTION

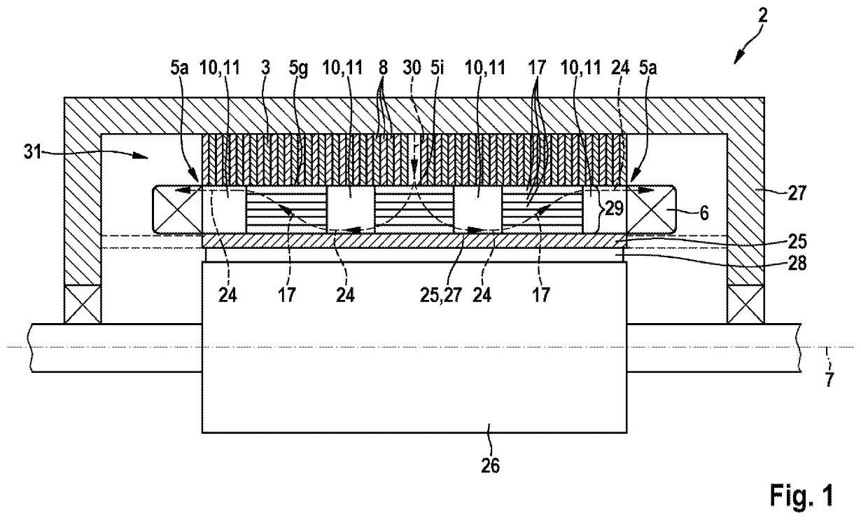

FIG. 1 shows a sectional view of an electric machine with a stator and a rotor.

The stator 1 of an electric machine 2 according to the invention comprises a laminated core 3, on which stator teeth 4 and stator grooves 5 located between the stator teeth 4 are formed, and which extends about a stator axis 7. The stator 1 also comprises a stator winding 6 extending in the stator grooves 5. The laminated core 3 is formed from a stack of laminations 8, in particular, sheet metal laminations.

The stator teeth 4 are joined to one another via an annular stator yoke 9. The stator grooves 5 each have a groove base 5g facing the stator yoke 9 and a groove slot 5s facing away from the groove base 5g and formed between tooth ends 4e.

A single conductor 15 or a conductor bundle 29 comprising a plurality of conductors 15, in particular, a stack of flat wire conductors, is provided in each of the stator grooves 5 to form the electrical stator winding 6.

The electric machine 2 further comprises a rotor 26, which is rotatable about the stator axis 7, and a housing 27. An air gap 28 is formed between the stator 1 and the rotor 26.

In the laminated core 3, for example, at least one supply path 30 may be formed, which is provided for supplying cooling medium to the cooling paths 17, and in each case opens to the stator grooves 5 via a groove inlet 5i. In the respective stator groove 5, starting from the respective groove inlet 5i, two cooling paths 17 are provided, for example, extending in opposite directions and, in particular, meandering, which emerge at the ends of the respective stator groove 5 as a free jet via a groove outlet 5a.

Alternatively, the two winding heads of the stator winding 6 may each be arranged in a winding head cooling chamber 31 of the housing 27 that is delimited along the dashed lines, wherein the two winding head cooling chambers 31 are in fluid communication with one another via the cooling paths 15 that lead through the stator grooves 6 and are, in particular, meandering.

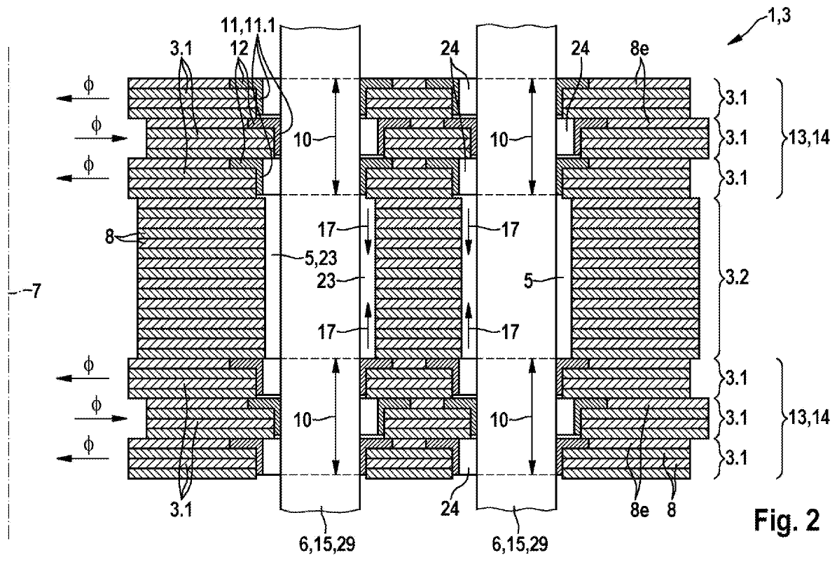

FIG. 2 shows a partial view of a stator according to FIG. 1 with a plurality of turned first stator partial cores, in the stator grooves of which protective sleeves according to the invention are provided according to a first exemplary embodiment.

In the laminated core 3, at least one set 13 of three first stator partial cores 3.1, turned in opposite directions about the stator axis 7, is provided for clamping the stator winding 6 at clamping points 10 of the stator grooves 5. Two of the first stator partial cores 3.1 of each set 13 are turned about the stator axis 7 by a turn angle +in one circumferential direction, and the remaining first stator partial packet 3.1 of the set 13 is turned about the stator axis 7 by the turn angle +in the opposite direction. The laminations 8 of the respective first stator partial core 3.1 are firmly joined to one another, in particular, by adhesive bonding, stacking/press-packing, welding or baking.

An axial support bearing region 14 may be formed in the laminated core 3 with a set 13 of first stator partial cores 3.1. In each support bearing region 14 of the laminated core 3, the stator winding 6 is clamped locally at the clamping points 10 in all stator grooves 5. The respective clamping point 10 is an axial region in the respective stator groove 5. According to the exemplary embodiment, a plurality of, for example two, three or four, support bearing regions 14 are provided in the laminated core 3, which are spaced apart from one another, for example, in the axial direction.

Protective sleeves 11 are provided in the stator grooves 5 of the laminated core 3 in the region of the turned first stator partial cores 3.1, which protect the stator winding 6 from damage by the turned first stator partial cores 3.1 and, in particular, are designed to be electrically insulating.

According to the invention, it is provided that at least one of the protective sleeves 11 has at least one collar 12, which is angled relative to a groove section 11.1 of the protective sleeve 11. The collar 12 supports the protective sleeve 11 in the axial direction relative to the stator axis 7 on one of the stator teeth 4 of one of the first stator partial cores 3.1, and in doing so determines the axial position of the protective sleeve 11 in the respective stator groove 5.

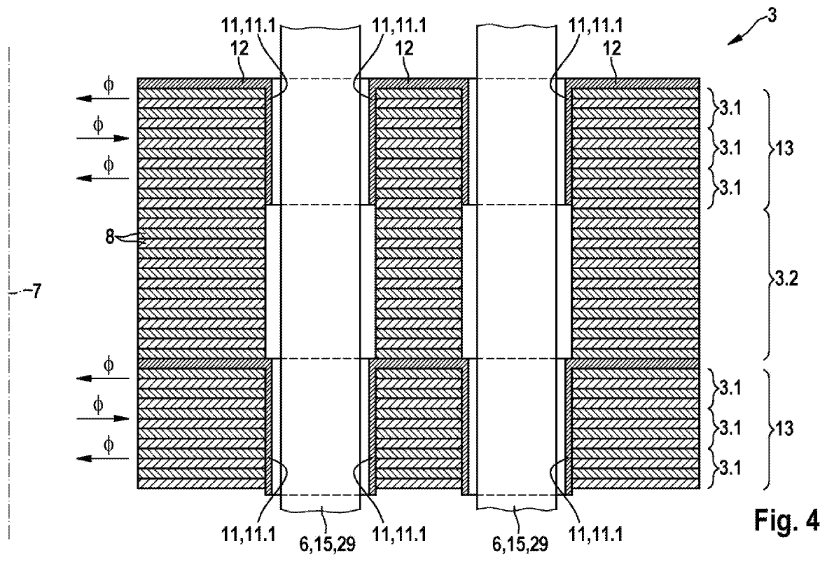

In the laminated core 3, according to FIG. 2 and FIG. 4, at least one second stator partial core 3.2 may be provided, which is arranged between first stator partial cores 3.1 of a set 13 of first stator partial cores 3.1, and/or between two sets 13 of first stator partial cores 3.1, and which is oriented in the circumferential direction such that the conductors 15 of the stator winding 6 in each stator groove 5 of the second stator partial core 3.2 extend along the respective stator groove 5 at a distance from the two tooth flanks 4f of the stator groove 5, in doing so forming slot-gap channels 23 in the stator grooves 5. The laminations 8 of the respective second stator partial core 3.2 are, for example, firmly joined to one another, in particular by adhesive bonding, stacking/press-packing welding or baking.

The stator grooves 5 may each be flowed through by a cooling medium, in particular oil, along a cooling path 17, which is, in particular, meandering in shape. Bypasses 24 for flow bypassing the clamping points 10 may be designed on the protective sleeves 11, in particular, as an indentation or recess on one of the inner narrow sides 22, in particular, specifically on an inner narrow side 22 facing or facing away from the stator yoke 9.

For sealing the groove slots 5s, a stator sleeve 25 may be provided at the inner diameter of the laminated core 3.

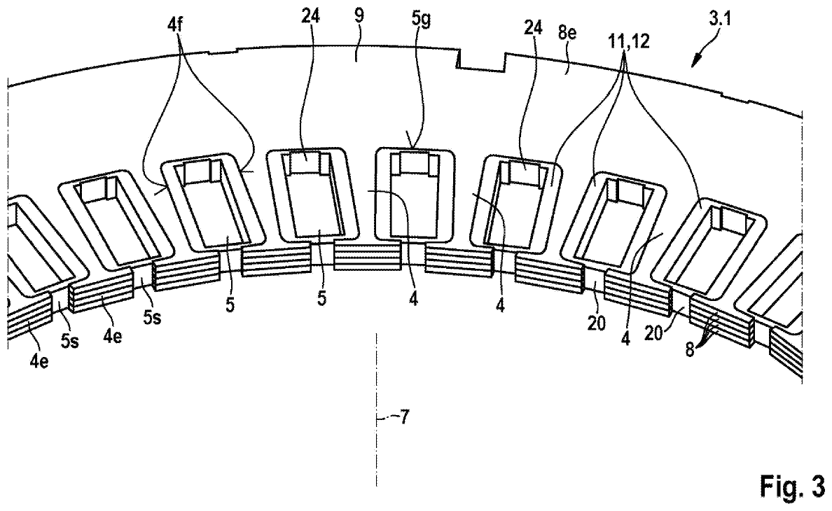

FIG. 3 shows an individual first stator partial core according to FIG. 2 with protective sleeves according to the invention, according to a first exemplary embodiment.

According to the first exemplary embodiment, the respective protective sleeve 11 extends in the axial direction only in one of the first stator partial cores 3.1 of a set 13.

The collar 12 of the respective protective sleeve 11 is formed on at least one flank side 21, which faces a tooth flank 4f of the respective stator groove 5, and/or on a narrow side 22 connecting the flank sides 21.

According to FIG. 2 and FIG. 3, the respective first stator partial core 3.1 may have at least one end lamination 8e on at least one of the two end faces, the groove contours of which are set back relative to the other plates 8, to form an installation space for accommodating the collar 12 of the respective protective sleeve 11. In addition, the collar 12 of the respective protective sleeve 11 may be clamped between the laminations 8 of the laminated core 3 in the axial direction relative to the stator axis 7.

FIG. 4 shows a partial view of a stator according to FIG. 1 with a plurality of as yet unturned first stator partial cores, in the stator grooves of which protective sleeves according to the invention, are provided according to a second exemplary embodiment.

According to the second exemplary embodiment, the respective protective sleeve 11 extends in all first stator partial cores 3.1 of the set 13, i.e., starting from collar 12 in the respective stator groove 5 across all first stator partial cores 3.1 of the set 13.

According to a second exemplary embodiment, the collars 12 of a plurality of, in particular, all, protective sleeves 11 of one of the first stator partial cores 3.1 or of a set 13 of first stator partial cores 3.1 may be integrally joined so as to form a protective sleeve unit 16. The protective sleeve unit 16 has a lamination section 16.1 for connecting the protective sleeves 11. The lamination section 16.1 of the protective sleeve unit 16 is arranged in a plane between two laminations 8 of the laminated core 3.

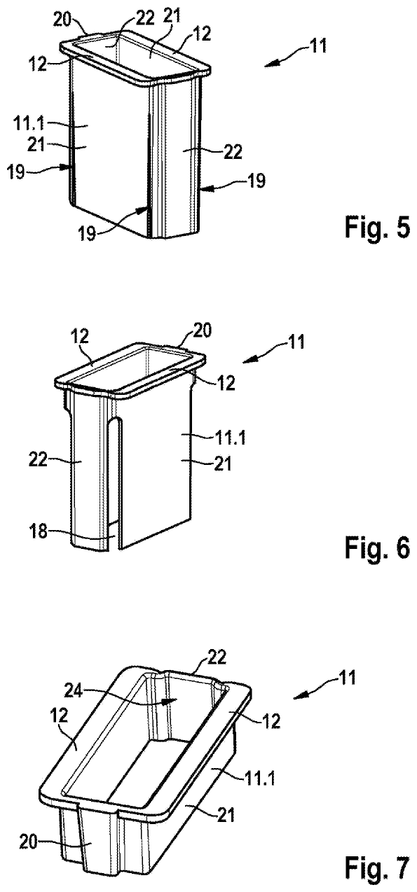

The protective sleeves 11 may be closed in the circumferential direction as shown in FIG. 5 or interrupted with slot(s) 18 as shown in FIG. 6. According to FIG. 6, for example, slots 18 are provided on edges 19 of the protective sleeves 11 that extend in the axial direction.

The groove section 11.1 of the protective sleeves 11 is formed, for example, in accordance with the shape of the stator grooves 5. Thus, the groove section 11.1 of the protective sleeves 11 may be designed in cross-section to be trapezoidal, rectangular, sleeve-shaped, and partially trapezoidal, partially rectangular, or U-shaped.

The protective sleeves 11 may be made of plastic, in particular, an elastomer or a thermoplastic elastomer, or of ceramic.

FIG. 7 shows a further view of the protective sleeve according to FIG. 5.

The protective sleeves 11 may have, on a narrow side 22 facing away from the stator yoke 9, a radially projecting web section 20 which extends into the respective groove slot 5s and extends in the axial direction.

1. A stator of an electric machine (2) having a laminated core (3) comprising sheet metal laminations (8), on which laminated core stator teeth (4) and stator grooves (5) located between the stator teeth (4) are formed, and which extends about a stator axis (7), and having a stator winding (6) running in the stator grooves (5), wherein at least one set (13) of three oppositely turned first stator partial cores (3.1) is provided for clamping the stator winding (6) at clamping points (10) of the stator grooves (5), wherein two of the first stator partial cores (3.1) of the respective set (13) are turned in one circumferential direction, and the remaining first stator partial core (3.1) of the set (13) is turned in an opposite direction about the stator axis (7), wherein protective sleeves (11) are provided in the stator grooves (5) of the laminated core (3) in a region of the turned first stator partial cores (3.1), which protect the stator winding (6) from damage by the turned first stator partial cores (3.1), wherein
at least one of the protective sleeves (11) has at least one collar (12), which is angled relative to a groove section (11.1) of the protective sleeve (11), and is provided for axial support on one of the stator teeth (4) of one of the first stator partial cores (3.1).

2. The stator according to claim 1, wherein the at least one collar (12) of the respective protective sleeve (11) is formed on at least one flank side (21), which faces a tooth flank (4f) of the respective stator groove (5), and/or on a narrow side (22) connecting the flank sides (21).

3. The stator according to claim 1, wherein the respective first stator partial core (3.1) comprises at least one end lamination (8e) on at least one of [[the ]]two end faces, the groove contours of which are set back relative to the remaining laminations (8), to form an installation space for accommodating the at least one collar (12) of the respective protective sleeve (11), and/or wherein the at least one collar (12) of the respective protective sleeve (11) is clamped between laminations (8) of the laminated core (3).

4. The stator according to claim 1, wherein the at least one collar (12) of a plurality of the protective sleeves (11) of one of the first stator partial cores (3.1), or of a set (13) of first stator partial cores (3.1), are integrally joined to form a protective sleeve unit (16), wherein the protective sleeve unit (16) has a laminated section (16.1) for connecting the protective sleeves (11), wherein the laminated section (16.1) of the protective sleeve unit (16) is formed in a plane between two laminations (8) of the laminated core (3).

5. The stator according to claim 1, wherein the respective protective sleeve (11) extends in an axial direction only in one of the first stator partial cores (3.1) of the respective set (13), or extends in all first stator partial cores (3.1) of the set (13).

6. The stator according to claim 1, wherein the protective sleeves (11) are closed in the circumferential direction or interrupted by a slot (18), wherein the slot (18) is provided running in an axial direction.

7. The stator according to claim 1, wherein the groove section (11.1) of the protective sleeves (11) is configured to match a shape of the stator grooves (5).

8. The stator according to claim 1, wherein the material of the respective protective sleeve (11) is a plastic or a ceramic.

9. The stator according to claim 1, wherein the stator teeth (4) are joined to one another via an annular stator yoke (9) and each have a tooth end (4e) which faces away from the stator yoke (9), and is configured, as a tooth head, wherein the stator grooves (5) have groove slots (5s) formed between the respective tooth ends (4e), wherein a radially projecting web portion (20) is formed on a narrow side (22) of the respective protective sleeve (11) facing away from the stator yoke (9), which web portion extends into the respective groove slot (5s) and extends in an axial direction.

10. The stator according to claim 9, wherein the stator grooves (5) may each be flowed through by a cooling medium along a cooling path (17), wherein bypasses (24) are provided on the protective sleeves (11) for bypassing the clamping points (10).

11. The stator according to claim 1, wherein at least one second stator partial core (3.2) is provided in the laminated core (3), which is arranged between first stator partial cores (3.1) of a set (13) of first stator partial cores (3.1), and/or between two sets (13) of first stator partial cores (3.1), and is oriented in the circumferential direction in such a way that conductors (15) of the stator winding (6) run in each stator groove (5) of the second stator partial core (3.2) along the stator groove (5) at a distance from two tooth flanks (4f) of the stator groove (5), as a result of which groove gap channels (23) are formed in the stator grooves (5).

12. An electric machine (2) with a stator (1) according to claim 1.

13. The stator according to claim 1, wherein the protective sleeves (11) are electrically insulating.

14. The stator according to claim 6, wherein the slot (18) is provided on edges (19) of the protective sleeves (11).

15. The stator according to claim 7, wherein the groove section (11.1) of the protective sleeves (11) is trapezoidal, rectangular, sleeve-shaped, partially trapezoidal, partially rectangular or U-shaped in cross-section.

16. The stator according to claim 8, wherein the material of the respective protective sleeve (11) is an elastomer or thermoplastic elastomer.

17. The stator according to claim 10, wherein the bypasses (24) are provided on one of the inner narrow sides (22) of the protective sleeves (11).

18. The stator according to claim 17, wherein the bypasses (24) are provided on an inner narrow side (22) facing or facing away from the stator yoke (9).
